(19) United States
(12) Patent Application Publication
(10) Pub. No.: US 2021/0388272 A1
(43) Pub. Date: Dec. 16, 2021

(54) METHOD FOR FIXED-BED REFORMING USING A CATALYST HAVING A PARTICULAR FORM

(71) Applicant: IFP Energies Nouvelles, Rueil-Malmaison Cedex (FR)

(72) Inventors: Bogdan HARBUZARU, Rueil-Malmaison Cedex (FR); Sylvie LACOMBE, Rueil-Malmaison Cedex (FR); Jacques LAVY, Rueil-Malmaison Cedex (FR); Christophe VALLEE, Rueil-Malmaison Cedex (FR); Pierre-Yves LE GOFF, Rueil-Malmaison (FR); Kevin DEBOLT, Williamstown, WV (US)

(73) Assignee: IFP Energies Nouvelles, Rueil-Malmaison Cedex (FR)

(21) Appl. No.: 17/292,158

(22) PCT Filed: Oct. 21, 2019
(86) PCT No.: PCT/EP2019/078574

§ 371 Date: May 7, 2021

(30) Foreign Application Priority Data
Nov. 8, 2018 (FR) 1871420

(51) Int. Cl. C10G 35/085; B01J 35/10; B01J 21/04; B01J 37/02; B01J 37/18; B01J 6/00; B01J 23/42; B01J 8/02; B01J 35/02

(52) U.S. Cl. CPC C10G 35/085; B01J 35/1061; B01J 35/1042; B01J 35/1038; B01J 35/1019; B01J 35/023; B01J 37/0201; B01J 37/18; B01J 6/001; B01J 23/42; B01J 8/02; B01J 21/04

(57) ABSTRACT

Process for fixed-bed reforming of a hydrocarbon-based feedstock comprising n-paraffinic, naphthenic and aromatic hydrocarbons, at a temperature of between 400 and 700° C., a pressure of between 0.1 and 4 MPa, and a mass flow of feedstock treated per unit mass of catalyst and per hour of between 0.1 and 10 h⁻¹, by bringing said feedstock into contact with a catalyst comprising platinum, a promoter metal selected from the group consisting of rhenium and iridium, a halogen selected from the group consisting of fluorine, chlorine, bromine and iodine, and a porous alumina support in the form of an extrudate characterized by a length “l” of between 1 and 10 mm, a section comprising four lobes, the largest diameter “D” of the cross section of said extrudate being between 1 and 3 mm.

### TECHNICAL FIELD

The invention relates to the technical field of refining and in particular to reforming. The present invention more particularly relates to a process for fixed-bed catalytic reforming using a catalyst with a specific morphology.

### PRIOR ART

The process of catalytic reforming is a process that is very widely used by refiners in order to add value to the heavy petrol obtained by distillation. The hydrocarbons of the heavy petrol feedstock (paraffins and naphthenes) containing from 5 to 12 carbon atoms approximately per molecule are converted during this process into aromatic hydrocarbons or otherwise into branched paraffins. This conversion is obtained at high temperature (of the order of 500° C.), at low to medium pressure (3.5 to 25×10⁵ Pa) and in the presence of a catalyst. Catalytic reforming produces reformate which makes it possible to improve the rating of petroleum cuts. Reformate is predominantly formed of C5+ compounds (compounds containing at least 5 carbon atoms). This process also produces a hydrogen-rich gas, a combustible gas (formed by C1-C2 compounds) and liquefied gases (formed by C3-C4 compounds). Finally, coke formation also occurs, especially by condensation of aromatic rings forming a solid, carbon-rich product which is deposited on the active sites of the catalyst. The reactions that produce C1-C4 compounds (also referred to as C4) and coke have an adverse effect on the reformate yield and on the stability of the catalyst. The strong activity of the catalyst must be combined with as high a selectivity as possible; that is to say that the cracking reactions leading to light products containing 1 to 4 carbon atoms (C4) must be limited.

There are two large categories of reforming catalyst: on the one hand, catalysts for fixed beds (semi-regenerative process) and, on the other hand, catalysts for moving beds (continuous process). These are bifunctional catalysts, that is to say that they consist of two functions, one metal and one acid, each of the functions playing a well-defined role in the catalyst's activity. The metal function essentially ensures dehydrogenation of the naphthenes and paraffins and hydrogenation of the coke precursors. The acid function ensures isomerization of the naphthenes and paraffins and cyclization of the paraffins. The acid function is provided by the support itself, most commonly a halogenated pure alumina. The metal function is provided by a noble metal of the platinum group and at least one additional metal, mainly tin for the continuous process (moving bed) and rhenium in the semi-regenerative process (fixed bed).

These reforming catalysts are extremely sensitive, aside from coke, to various poisons or inhibitors liable to adversely affect their activity: in particular, nitrogen, metals and water. By being deposited on the surface of the catalyst, coke leads to a loss of activity over time, which leads to higher operating temperatures, a lower reformate yield and a shorter cycle duration. It is therefore important to seek to increase the activity of the catalysts in order to obtain high C5+ yields at as low a temperature as possible, so as to maximize the cycle duration of the catalyst. After a certain period of time, it is necessary to regenerate the catalyst to eliminate the coke and the inhibitors which have been deposited on the active sites thereof. Regeneration of reforming catalysts essentially comprises a step of controlled combustion in order to firstly eliminate the coke, and a step of oxychlorination which essentially makes it possible to redisperse the metals and to adjust the acidity of the alumina by adding chlorine or organic chlorinated compounds in an oxidizing medium. Treatments for regenerating the catalyst are carried out under very harsh conditions which may lead to its degradation, due to the high temperature and the presence of water of combustion. It is therefore important to seek to improve the stability of the catalyst by limiting the formation of coke, in order thereby to be able to increase the intervals between these regeneration phases as much as possible.

Generally, reforming catalysts are in the form of beads, cylinders or, more rarely, trilobes. It is well known to those skilled in the art that the step of shaping the reforming catalyst is important due to its impact on the pressure drop experienced as the effluent passes through the bed of catalyst. Indeed, it is desirable to limit this pressure drop so as to control on the one hand the operational pressure of the process, which has an impact on the C5+ yields, and, on the other hand, to limit the energy consumption of the pumps and compressors of the unit. Likewise, it is generally known that the activity of the catalyst increases with decreasing bead, cylinder or trilobe size, in the case of internal diffusional limitations. However, as the size of the beads, cylinders or trilobes decreases, the pressure drop usually increases until it reaches unsustainable levels. By virtue of the use of specific catalyst morphologies, the pressure drops can be reduced for smaller beads, cylinders or trilobes, which increases activity.

### SUBJECTS OF THE INVENTION

However, to date, no real distinction has been made regarding the advantage that the morphology of a catalyst provides to its stability. Surprisingly, the applicant has discovered that using a catalyst in the form of a quadrilobal extrudate, i.e. an extrudate having a section comprising four lobes, in a fixed-bed reforming process, makes it possible to obtain improved performance in terms of stability compared to the performance of catalysts in cylinder form, or in the form of extrudates with other geometries, in particular in trilobe form, while retaining good performance in terms of activity.

One subject according to the invention relates to a process for fixed-bed reforming of a hydrocarbon-based feedstock comprising n-paraffinic, naphthenic and aromatic hydrocarbons containing from 5 to 12 carbon atoms per molecule at a temperature of between 400 and 700° C., a pressure of between 0.1 and 4 MPa, and a mass flow of feedstock treated per unit mass of catalyst and per hour of between 0.1 and 10 h⁻¹, by bringing said feedstock into contact with a catalyst comprising at least platinum, at least one promoter metal selected from the group consisting of rhenium and iridium, at least one halogen selected from the group consisting of fluorine, chlorine, bromine and iodine, and a porous alumina support in the form of an extrudate characterized by a length “I” of between 1 and 10 mm, a section comprising four lobes, and preferably consisting of four lobes, which section is referred to as quadrilobal, and such that the largest diameter “D” of the cross section of said extrudate is between 1 and 3 mm.

Preferably, the largest diameter “D” of the cross section of said extrudate of quadrilobal section is between 1.1 and 2.2 mm.

Preferably, said extrudate of quadrilobal section has a length “l” of between 2 and 7 mm.

In one embodiment according to the invention, said section of the extrudate of quadrilobal section has symmetrical lobes.

In another embodiment according to the invention, said section of the extrudate of quadrilobal section has asymmetrical lobes.

In one embodiment according to the invention, said extrudate of quadrilobal section is an axial extrudate.

In another embodiment according to the invention, said extrudate of quadrilobal section is a helical extrudate having a rotation pitch of between 10 and 180° per mm.

Preferably, the platinum content of said catalyst relative to the total weight of the catalyst is between 0.02 and 2% by weight.

Preferably, the rhenium or iridium content of said catalyst is between 0.02 and 10% by weight relative to the total weight of the catalyst.

Preferably, said catalyst also comprises at least one dopant selected from the group consisting of gallium, germanium, indium, tin, antimony, thallium, lead, bismuth, titanium, chromium, manganese, molybdenum, tungsten, rhodium, zinc and phosphorus.

Preferably, the content of said dopant is between 0.01 and 2% by weight relative to the weight of the catalyst.

Preferably, the halogen content of said catalyst is between 0.1 and 15% by weight relative to the total weight of the catalyst.

Preferably, the halogen is chlorine and the content thereof is between 0.5 and 2% by weight relative to the total weight of the catalyst.

Preferably, the specific surface area of said porous support is between 150 and 400 m²/g.

Preferably, the volume of the pores of the support having a diameter of less than 10 microns is between 0.2 and 1 cm³/g, and the mean diameter of the mesopores is between 5 and 20 nm.

### DETAILED DESCRIPTION OF THE INVENTION

### Definitions

Hereinafter, groups of chemical elements are given according to the CAS classification (CRC Handbook of Chemistry and Physics, CRC Press, Editor in Chief D. R. Lide, 81st edition, 2000-2001). For example, group IB according to the CAS classification corresponds to the metals of column 11 according to the new IUPAC classification.

In the following description of the invention, specific surface area is intended to mean the BET specific surface area, determined by nitrogen adsorption in accordance with standard ASTM D 3663-78, developed from the Brunauer-Emmett-Teller method described in the journal “Journal of the American Chemical Society”, 60, 309, (1938).

Largest diameter “D” is intended to mean the largest diameter of the equivalent circle that passes through the ends of two opposite lobes.

### LIST OF FIGURES

FIG. 1 is a graph illustrating the temperature profile:
of a catalyst A (not in accordance) comprising a support of cylindrical extruded form (succession of round points);
of a catalyst B (not in accordance) comprising a support of trilobal extruded form (succession of diamond-shaped points);
of a catalyst C in accordance with the invention comprising a support of quadrilobal extruded form (succession of triangular points).

The x-axis represents the time under load (in hours) and the y-axis represents the temperature of the catalytic bed (in ° C.). This graph makes it possible to characterize the stability of the catalyst by calculating the gradient of the temperature between two given times under load. The gradient is thus expressed in ° C./day (° C./d). The shallower the gradient, the more the catalyst is considered to be stable.

FIGS. 2a, 3a and 4a are cross-sectional representations of examples of catalysts of quadrilobal type used in the context of the process according to the invention. More particularly, FIG. 2a is a sectional representation of an example of a symmetrical quadrilobal catalyst, FIG. 3a is a sectional representation of an example of an asymmetrical quadrilobal catalyst of “butterfly” type, and FIG. 4a is a sectional representation of an example of an asymmetrical quadrilobal catalyst of “batman” type.

FIGS. 2b, 3b and 4b show photographs of the catalysts represented in FIGS. 2a, 3a and 4a.

### DETAILED DESCRIPTION

For the purposes of the present invention, the different embodiments presented may be used alone or in combination with one another, without any limit to the combinations.

The reforming process makes it possible to increase the octane number of the petrol fractions originating from the distillation of crude petroleum and/or other refining processes. Processes for producing aromatics provide the bases (benzene, toluene and xylene) of use in the petrochemical industry. These processes have an additional benefit, contributing to the production of large amounts of hydrogen, essential for the refining processes of hydrotreatment or hydroconversion. The hydrocarbon-based feedstock used in the context of the process according to the invention contains n-paraffinic, isoparaffinic, naphthenic and aromatic hydrocarbons containing from 5 to 12 carbon atoms per molecule. This feedstock is defined, inter alia, by its density and its composition by weight.

The fixed-bed reforming process according to the invention is carried out by bringing a hydrocarbon-based feedstock (detailed below) into contact with a specific reforming catalyst (detailed further below in the description) at a temperature of between 400 and 700° C., preferably between 350 and 550° C., a pressure of between 0.1 and 4 MPa, preferably between 1 and 3 MPa, and a mass flow of feedstock treated per unit mass of catalyst and per hour of between 0.1 and 10 h⁻¹, preferably between 0.5 and 6 h⁻¹. A portion of the hydrogen produced is recycled at a molar recycling rate (flow rate of hydrogen recycled over flow rate of hydrocarbon-based feedstock) of between 0.1 and 8, preferably between 2 and 7.

The hydrocarbon-based feedstock to be treated generally contains paraffinic, naphthenic and aromatic hydrocarbons containing from 5 to 12 carbon atoms per molecule. This feedstock is defined, inter alia, by its density and its composition by weight. These feedstocks may have an initial boiling point of between 40° C. and 70° C. and a final boiling point of between 160° C. and 220° C. They may also be formed by a petrol fraction or mixture of petrol fractions having initial and final boiling points between 40° C. and 220° C. The feedstock to be treated may thus also be formed by a heavy naphtha having a boiling point of between 160° C. and 200° C.

The catalyst used in the context of the process according to the invention comprises at least platinum. The platinum content relative to the total weight of the catalyst may be between 0.02 and 2% by weight, preferably between 0.05 and 1.5% by weight, even more preferably between 0.1 and 0.8% by weight.

The catalyst comprises one or more promoter metals, the effect of which is to promote the dehydrogenating activity of the platinum, to limit side reactions of C—C bond breakage and to stabilize the metal phase. The promoter metals are selected from the group consisting of rhenium and iridium. The content of each promoter metal may be between 0.02 and 10% by weight relative to the total weight of the catalyst, preferably between 0.05 and 5% by weight, even more preferably between 0.1 and 2% by weight.

The catalyst used in the context of the process according to the invention may also comprise at least one dopant selected from the group consisting of gallium, germanium, indium, tin, antimony, thallium, lead, bismuth, titanium, chromium, manganese, molybdenum, tungsten, rhodium, zinc and phosphorus. Preferably, several dopants are used in the context of the process according to the invention. The content of each dopant may be, relative to the total weight of the catalyst, between 0.01 and 2% by weight, preferably between 0.01 and 1% by weight, more preferentially between 0.01 and 0.7% by weight.

The catalyst used in the context of the process according to the invention may also comprise at least one halogen used to acidify the alumina support. The halogen content may represent between 0.1 and 15% by weight relative to the total weight of the catalyst, preferably between 0.2 and 5% relative to the total weight of the catalyst. Preferably, a single halogen is used, in particular chlorine. When the catalyst comprises a single halogen, which is chlorine, the chlorine content is between 0.5 and 2% by weight relative to the total weight of the catalyst.

The porous support of the catalyst used in the context of the process according to the invention is based on alumina. The alumina(s) of the porous support used in the catalyst may be of the χ, η, γ or δ type. They are preferably of γ or δ type. They are even more preferably of γ type.

Advantageously, the specific surface area of said porous support is between 150 and 400 m²/g, preferably between 150 and 300 m²/g, even more preferably between 160 and 250 m²/g. The volume of the pores having a diameter of less than 10 microns is preferably between 0.2 and 1 cm³/g, preferably between 0.4 and 0.9 cm³/g. The mean diameter of the mesopores (pores having a diameter of between 2 and 50 nm) is preferably between 5 and 20 nm, preferably between 7 and 16 nm.

According to an essential aspect of the invention, the specific morphology of the porous support makes it possible to unexpectedly increase the stability of the catalyst while retaining an activity that is at least as good as the activity of the reforming catalysts that are in the form of extrudates of cylinder or trilobe type.

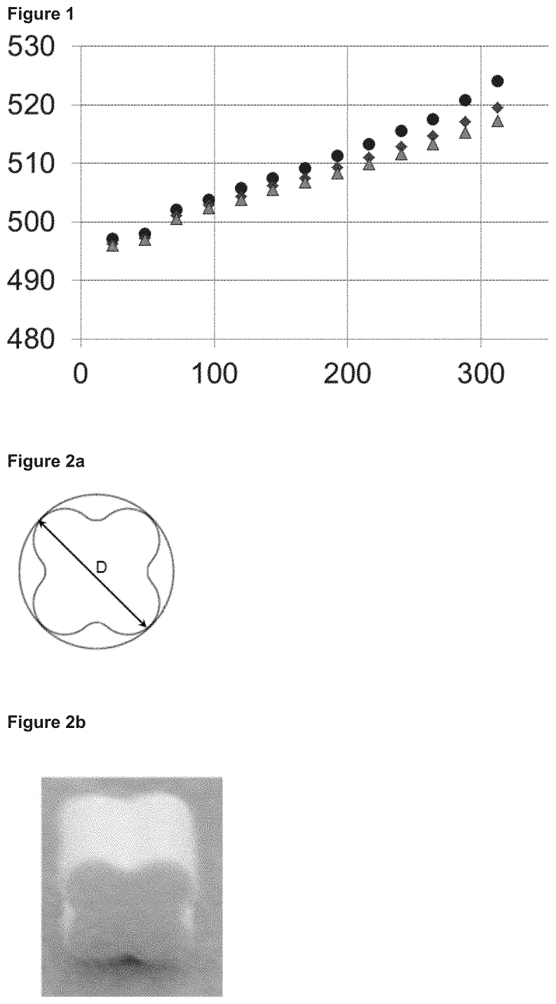

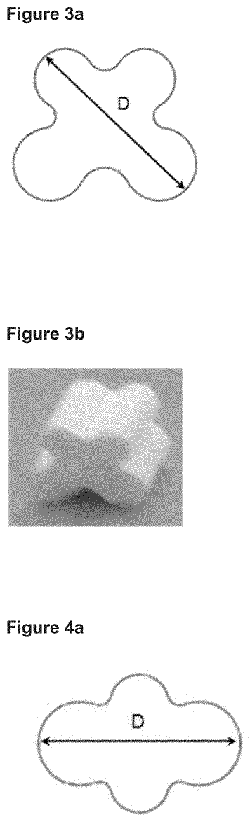

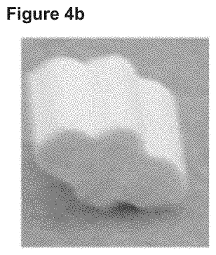

The porous support is in the form of extrudates, the section of which comprises four lobes, and preferably consists of four lobes. The section of the extrudate (perpendicular to the axis of extrusion) may have symmetrical lobes. By way of example and nonlimitingly, FIGS. 2a and 2b show an example of a quadrilobal extrudate having symmetrical lobes (the four lobes are identical). The section of the extrudate (perpendicular to the axis of extrusion) may also have asymmetrical lobes. By way of example and nonlimitingly, FIGS. 3a to 4b show an example of a quadrilobal extrudate having asymmetrical lobes (that is to say that at least one lobe is different from the other lobes).

The porous support may be in the form of a straight extrudate of quadrilobal section or in the form of a helical extrudate having a rotation pitch of between 10 and 180° per mm.

More particularly, the length of the extrudate of quadrilobal section is between 1 and 10 mm, preferably between 2 and 7 mm.

The largest diameter “D” of the cross section of the extrudate of quadrilobal section is preferably between 1 and 3 mm, preferably between 1.1 and 2.2 mm. Largest diameter “D” is intended to mean the largest diameter of the equivalent circle that passes through the ends of two opposite lobes.

The porous support based on alumina may be synthesized by different methods known to those skilled in the art.

According to one embodiment, the porous support based on alumina is prepared from a boehmite powder obtained by hydrolysis of aluminium alkoxides. Examples of boehmite powders prepared by hydrolysis of aluminium alkoxides may be found in patents FR 1391644 or U.S. Pat. No. 5,055,019. This boehmite powder is then shaped, for example by compounding and extrusion. One or more heat treatments may then lead to obtaining alumina. Preferably, the heat treatment is a calcination under dry air at a temperature of between 540° C. and 800° C.

According to another embodiment, the porous support based on alumina is prepared from a boehmite powder obtained by a reaction of precipitation from aluminium salts. The boehmite powder may for example be obtained by precipitation of basic and/or acidic solutions of aluminium salts, caused by changing the pH or any other method known to those skilled in the art. This gel is then shaped, for example by compounding-extrusion. A series of heat treatments of the product are then carried out, leading to obtaining the alumina. This method is also described in the part entitled “Alumina” by P. Euzen, P. Raybaud, X. Krokidis, H. Toulhoat, J. L. Le Loarer, J.P. Jolivet and C. Froidefond, in “Handbook of Porous Solids” (F. Schüth, K. S. W. Sing and J. Weitkamp, Wiley-VCH, Weinheim, Germany, 2002).

Preferably, the porous support is prepared from a boehmite powder obtained by hydrolysis of alkoxides.

The catalyst used in the context of the process according to the invention may be prepared by deposition of the different constituents thereof on the alumina support. Each constituent may be deposited on the alumina support before or after said support has been shaped. The constituents may be introduced successively in any order, from one solution or from separate solutions. In the latter case, intermediate drying and/or calcination operations may be carried out.

The different constituents of the catalyst may be deposited by conventional techniques, in the liquid phase or the gas phase, from suitable precursor compounds. When the different constituents of the catalyst are deposited before the support is shaped, the techniques used may for example be dry impregnation or impregnation in excess on boehmite powder, or else mixing of the solution(s) containing the constituent during the compounding or mixing step before extrusion. When the deposition is carried out on the shaped alumina support, the techniques used may for example be dry impregnation or impregnation with excess of solution. Steps of washing and/or drying and/or calcination may optionally be carried out before each new impregnation step.

The platinum may be deposited by conventional techniques, especially impregnation from an aqueous or organic solution of a precursor of platinum or containing a platinum compound or salt. By way of examples of salts or compounds that may be used, mention may be made of hexachloroplatinic acid, aqueous ammonia-based compounds, ammonium chloroplatinate, platinum chloride, dicarbonyl platinum dichloride and hexahydroxyplatinic acid. The aqueous ammonia-based compounds may for example be tetramine platinum(II) salts of formula Pt(NH₃)₄X₂, complexes of platinum with halogen-polyketones and halogenated compounds of formula H(Pt(acac)₂X) in which the element X is a halogen selected from the group consisting of chlorine, fluorine, bromine and iodine and preferably chlorine, and the acac group represents the acetylacetone-derived residue of formula C₅H₇O₂. Among the organic solvents that may be used, mention may be made of paraffinic, naphthenic or aromatic hydrocarbons and halogenated organic compounds having for example 1 to 12 carbon atoms per molecule. Mention may be made, for example, of n-heptane, methylcyclohexane, toluene and chloroform. Use may also be made of mixtures of solvents. The platinum may be deposited at any time during the preparation of the catalyst. It may be carried out in isolation or simultaneously to the deposition of other constituents, for example the promoter metal(s).

The dopant(s) and/or the promoter(s) may also be deposited by conventional techniques, starting from precursor compounds such as phosphorus-based compounds, halides, nitrates, sulfates, acetates, tartrates, citrates, carbonates or oxalates of the dopant metals and complexes of amine type. In the case of metal precursors or dopants, any other salt or oxide of these metals that is soluble in water, acids or in another suitable solvent, is also suitable as precursor. By way of examples of such precursors, mention may thus be made of perrhenic acid, perrhenates, chromates, molybdates, tungstates, gallium chloride, gallium nitrate, thallium acetate, thallium nitrate, indium acetylacetonate, indium nitrate, indium acetate, indium trifluoroacetate, indium chloride, bismuth acetate, bismuth nitrate, H₃PO₄, a solution of (NH₄)₂HPO₄, a solution of Na₂HPO₄ and a solution of Na₃PO₄. It is also possible to introduce the dopant(s) by mixing an aqueous solution of their precursor compound(s) with the support before shaping thereof.

The dopant(s) and/or the promoter(s) may be deposited using a solution of an organometallic compound of said metals in an organic solvent. In this case, for example, this deposition is carried out after the deposition of the platinum, then the solid is calcined and a reduction is optionally carried out under pure or diluted hydrogen at high temperature, for example between 300 and 500° C. The organometallic compounds are selected from the group consisting of the complexes of said promoter metal and the metal hydrocarbyls such as metal alkyls, cycloalkyls, aryls, alkylaryls and arylalkyls. It is also possible to use compounds of alkoxide type or organohalogenated compounds. Mention may be made, in particular, of tetrabutyltin in the case in which the dopant is tin, and triphenylindium in the case in which the dopant is indium. The impregnation solvent may be selected from the group consisting of paraffinic, naphthenic or aromatic hydrocarbons containing from 6 to 12 carbon atoms per molecule and organic halogenated compounds containing from 1 to 12 carbon atoms per molecule. Mention may be made, for example, of n-heptane, methylcyclohexane and chloroform. Use may also be made of mixtures of the solvents defined above.

The halogen, preferably the chlorine, may be introduced to the catalyst at the same time as another metal constituent, for example in the case in which a halide is used as a precursor compound of the metal of the platinum group, of the promoter metal or of the dopant metal.

The halogen may also be added by means of impregnation by an aqueous solution of the corresponding acid, for example hydrochloric acid, at any time during the preparation. A typical protocol consists in impregnating the solid so as to introduce the desired amount of halogen. The catalyst is kept in contact with the aqueous solution for at least 30 minutes in order to deposit this amount of halogen.

The chlorine may also be added to the catalyst by means of an oxychlorination treatment. Such a treatment may for example be carried out between 350 and 550° C. for two hours under a flow of air containing the desired amount of chlorine and optionally containing water.

When the various precursors used in the preparation of the catalyst do not contain halogen, or contain an insufficient amount of halogen, it may be necessary to add a halogenated compound during the preparation. Any compound known to those skilled in the art may be used and incorporated at any one of the steps for preparing the catalyst. In particular, it is possible to use organic compounds such as methyl or ethyl halides, for example dichloromethane, chloroform, dichloroethane, methylchloroform or carbon tetrachloride.

The shaping of the porous support by extrusion, which is a method well known to those skilled in the art, may be carried out before or after all the constituents have been deposited on said porous support. The geometry of the die, which gives the extrudates their shape, is such that the extrudate has a section comprising four lobes, for which the largest diameter “D” of the cross section of said extrudate is between 1 and 3 mm. After shaping the porous support and deposition of all the constituents, a final heat treatment between 300 and 1000° C. is carried out, which may comprise only a single step at a temperature of 400 to 900° C. preferably, and under an atmosphere containing oxygen, and preferably in the presence of free oxygen or dry air. This treatment corresponds to the drying-calcination step following the deposition of the final constituent.

Before its use, the catalyst is subjected to a treatment under hydrogen and to a treatment using a sulfur-based precursor in order to obtain an active and selective metal phase. The procedure for this treatment under hydrogen, also referred to as reduction under hydrogen, consists in maintaining the catalyst in a stream of pure or diluted hydrogen at a temperature of between 100 and 600° C., and preferably between 200 and 580° C., for 30 minutes to 6 hours. This reduction may be carried out immediately after the calcination, or later by the user. It is also possible for the user to directly reduce the dried product. The procedure for treatment using a sulfur-based precursor is carried out after the reduction. It makes it possible to obtain a sulfur-based catalyst, the total sulfur content of which is between 700 and 1600 ppm relative to the total weight of the catalyst, preferably between 800 and 1400 ppm and even more preferably between 800 and 1300 ppm. “Total sulfur content” is intended to mean, within the meaning of the present invention, the total amount of sulfur present on the final catalyst obtained at the end of the sulfurization step, the sulfur being able to be in the form of sulfate and/or sulfur in the reduced state. The treatment with sulfur (also referred to as sulfurization) is carried out by any method that is well known to those skilled in the art. For example, the catalyst in reduced form is brought into contact with a sulfur-based precursor for 1 hour at a temperature between 450 and 580° C. in the presence of pure or diluted hydrogen. The sulfur-based precursor may be dimethyl disulfide, hydrogen sulfide, light mercaptans, organic sulfides such as, for example, dimethyl disulfide.

Thus, according to a nonlimiting example, it is possible to prepare the catalyst by a production process comprising the following steps:
1) a porous support based on alumina is prepared;
2) said porous alumina support is optionally impregnated with a solution containing a chlorine precursor;
3) said alumina support obtained in step 1) or 2) is impregnated with at least one solution of at least one platinum precursor;
4) said support obtained in the preceding step is impregnated with at least one solution of at least one promoter metal precursor;
5) said support obtained in the preceding step is impregnated with at least one solution of at least one dopant, this step being optional;
6) said support obtained in step 4) or 5) is calcined in order to obtain a catalyst in oxide form;
7) the catalyst in oxide form obtained in the preceding step is reduced under pure hydrogen at a temperature of for example between 100 and 600° C. and for 30 minutes to 6 hours in order to obtain a reduced catalyst;
8) the reduced catalyst obtained in the preceding step is brought into contact with at least one sulfur-based precursor for example, for at least one hour at a temperature of between 450° and 580° C.

Steps (2), (3), (4) and (5), the order of which can be reversed, may be carried out simultaneously or successively. At least one of steps (2), (3), (4) and (5) may be carried out before the step of shaping the support. Thus, if the porous support based on alumina according to step 1) is not directly provided in the form of an extrudate of length “I” of between 1 and 10 mm and of section comprising four lobes such that the largest diameter “D” of the cross section of said extrudate is between 1 and 3 mm, then the shaping of the support may be carried out between two of steps 1) to 6) (that is to say before the final step of drying-calcination).

The invention will now be described in the following exemplary embodiments, given by way of nonlimiting illustration.

### EXAMPLES

### Example 1: Preparation of a Catalyst a not in Accordance (Support in the Form of Cylindrical Extrudate)

A commercial boehmite powder resulting from a hydrolysis reaction of aluminium alkoxides is compounded with water then extruded through a cylindrical die 2 mm in diameter and calcined at 740° C. 20 g of this support are brought into contact for 3 hours with 100 cm³ of an aqueous solution of hydrochloric acid comprising 0.2 g of chlorine. The impregnation solution is then removed. The solid thus obtained is dried for 1 hour at 120° C. then calcined for 2 hours at 450° C. 100 cm³ of an aqueous solution of hexachloroplatinic acid comprising 0.07 g of platinum are then brought into contact with the support obtained at the end of the preceding step, for 3 hours. The amount of hydrochloric acid is adjusted in order to have a chlorine content of 1.1% by weight in the final catalyst. The impregnation solution is then removed. 60 cm³ of an aqueous solution comprising 0.09 g of rhenium introduced in the form of ammonium perrhenate are then brought into contact with the support obtained at the end of the preceding step, for 3 hours. The impregnation solution is then removed. The catalyst thus obtained is dried for 1 hour at 120° C., calcined for 2 hours at 520° C. then reduced under hydrogen for 2 hours at 520° C. The catalyst is then sulfurized with a hydrogen/H₂S mixture (1 vol % of H₂S) for 9 minutes at 520° C. (flow rate: 0.15 l/min under normal temperature and pressure conditions).

The final catalyst contains 0.25% by weight of platinum, 0.25% by weight of rhenium and 1.1% by weight of chlorine relative to the total weight of the catalyst.

### Example 2: Preparation of a Catalyst B not in Accordance (Support in the Form of Trilobal Extrudate)

The catalyst is prepared according to a protocol identical to example 1, except for the fact that the extrusion is carried out through a trilobal die, the largest diameter “D” of which is 2 mm.

### Example 3: Preparation of a Catalyst C in Accordance (Support in the Form of Quadrilobal Extrudate)

The catalyst is prepared according to a protocol identical to example 1, except for the fact that the extrusion is carried out through a symmetrical quadrilobal die (as shown in FIG. 2a), the largest diameter “D” of which is 2 mm.

### Example 4: Catalytic Test

The catalysts A to C are tested for the conversion of a hydrocarbon-based feedstock of naphtha type resulting from the distillation of petrol, the characteristics of which are as follows:
density at 15° C.: 0.761 kg/dm³
paraffins/naphthenes/aromatics: 44.1/38.7/17.2 vol %

This conversion is carried out in a pilot test unit in a continuous bed in the presence of hydrogen. The test is carried out using the following operating conditions:
total pressure: 1.2 MPa
feedstock flow rate: 4.8 kg per kg of catalyst per hour
research octane number: 102
molar ratio of hydrogen recycled to hydrocarbon-based feedstock: 2.5.

All the tests of the catalysts were carried out at a temperature that is variable but which makes it possible to obtain a constant research octane number (RON) equal to 102.

The temperature profile of catalysts A to C is shown in FIG. 1. This graph makes it possible to characterize the stability of the catalyst by calculating the gradient of the temperature between two given times under load. The gradient is thus expressed in ° C./day (° C./d). The shallower the gradient, the more the catalyst is considered to be stable. The catalyst C is more stable than the catalysts A and B, the gradient representing the increase in temperature as a function of time under load being the shallowest (cf. table 1 below). This better stability is also correlated with a lower carbon content (representative of the coke deposited on the catalyst) at the end of the test (cf. table 1 below).

TABLE 1
stability of the catalysts A to C and carbon content.

| | Temperature | |
|---|---|---|
| | gradient | Carbon content |
| | between 72 | at the end |
| | and 312 hours | of the test |
| | (° C./d) | (wt %) |
| Catalyst A | 2.2 | 10.6 |
| Catalyst B | 1.9 | 9.4 |
| Catalyst C | 1.7 | 9 |

1. Process for fixed-bed reforming of a hydrocarbon-based feedstock comprising n-paraffinic, naphthenic and aromatic hydrocarbons containing from 5 to 12 carbon atoms per molecule at a temperature of between 400 and 700° C., a pressure of between 0.1 and 4 MPa, and a mass flow of feedstock treated per unit mass of catalyst and per hour of between 0.1 and 10 h⁻¹, by bringing said feedstock into contact with a catalyst comprising at least platinum, at least one promoter metal selected from the group consisting of rhenium and iridium, at least one halogen selected from the group consisting of fluorine, chlorine, bromine and iodine, and a porous alumina support in the form of an extrudate characterized by a length “l” of between 1 and 10 mm, a section comprising four lobes and such that the largest diameter “D” of the cross section of said extrudate is between 1 and 3 mm.

2. Process according to claim 1, wherein the largest diameter “D” of the cross section of said extrudate is between 1.1 and 2.2 mm.

3. Process according to claim 1, wherein said extrudate has a length “l” of between 2 and 7 mm.

4. Process according to claim 1, wherein said section of the extrudate has symmetrical lobes.

5. Process according to claim 1, wherein said section of the extrudate has asymmetrical lobes.

6. Process according to claim 1, wherein said extrudate is an axial extrudate.

7. Process according to claim 1, wherein said extrudate is a helical extrudate having a rotation pitch of between 10 and 180° per mm.

8. Process according to claim 1, wherein the platinum content of said catalyst relative to the total weight of the catalyst is between 0.02 and 2% by weight.

9. Process according to claim 1, wherein the rhenium or iridium content of said catalyst is between 0.02 and 10% by weight relative to the total weight of the catalyst.

10. Process according to claim 1, wherein said catalyst also comprises at least one dopant selected from the group consisting of gallium, germanium, indium, tin, antimony, thallium, lead, bismuth, titanium, chromium, manganese, molybdenum, tungsten, rhodium, zinc and phosphorus.

11. Process according to claim 10, wherein the content of said dopant is between 0.01 and 2% by weight relative to the weight of the catalyst.

12. Process according to claim 1, wherein the halogen content of said catalyst is between 0.1 and 15% by weight relative to the total weight of the catalyst.

13. Process according to claim 1, wherein the halogen is chlorine and the content thereof is between 0.5 and 2% by weight relative to the total weight of the catalyst.

14. Process according to claim 1, wherein the specific surface area of said porous support is between 150 and 400 m²/g.

15. Process according to claim 1, wherein the volume of the pores of the support having a diameter of less than 10 microns is between 0.2 and 1 cm³/g, and the mean diameter of the mesopores is between 5 and 20 nm.
